(19) United States
(12) Patent Application Publication
(10) Pub. No.: US 2003/0107689 A1
(43) Pub. Date: Jun. 12, 2003

(54) Liquid crystal display

(76) Inventors: Chi Hyuck Park, Kyoungki-do (KR); Sung Hun Song, Kyoungki-do (KR); Seung Hee Lee, Cheollabuk-do (KR)

Correspondence Address: LADAS & PARRY, 224 SOUTH MICHIGAN AVENUE, SUITE 1200, CHICAGO, IL, 60604, US

(21) Appl. No.: 10/308,953

(22) Filed: Dec. 3, 2002

(30) Foreign Application Priority Data
Dec. 12, 2001 (KR) 2001-78623

(51) Int. Cl. G02F 1/1335

(52) U.S. Cl. 349/64; 349/112

(57) ABSTRACT

The present invention provides a liquid crystal display having improved contrast ratio. The present invention comprises: an upper and a lower glass substrates as a display, combined with a liquid crystal layer interposed therebetween; a liquid crystal panel comprising an upper and a lower polarizing plates arranged on the outside of the upper and the lower glass substrates; a lamp arranged on the lower part of the liquid crystal panel as a light source; a light guiding plate arranged on one side of the lamp; and a backlight unit comprising an optical film arranged on the upper part of the light guiding plate, wherein the upper polarizing plate has an Anti-Glare layer comprising dispersing particles.

### BACKGROUND OF THE INVENTION

1. Field of the Invention

The present invention relates to a liquid crystal display, and more particularly, to a liquid crystal display (hereinafter, referred to as “LCD”) having a high contrast ratio.

2. Description of the Related Art

A LCD generally has advantages of light weight, thin structure and low power consumption and therefore, it has been widely applied to a laptop computer, a cellular phone, a Car Navigation System (CNS) and a camcorder, etc.

The LCD realizes a screen using polarization and birefringence of light, comprising a backlight unit as a light source and a liquid crystal panel as a light switching device according to an optical structure.

FIGS. 1 to 3 are drawings showing an optical structure of a conventional LCD, wherein FIG. 1 shows the outline of LCD and FIGS. 2 and 3 are drawings enlarging a liquid crystal panel and a backlight unit in FIG. 1.

Referring to FIG. 1, the LCD comprises a liquid crystal panel 20 which is a substantial display device as a light switching device and a backlight unit 100 arranged on the lower part of the liquid crystal panel 20 as a light source since the liquid crystal panel 20 cannot emit light.

Referring to FIG. 2, the liquid crystal panel 20 has a structure that an upper and a lower glass substrates 11 and 12 are combined with a liquid crystal layer 13 interposed between them, which is twisted to a predetermined angle according to a refractivity, and an upper and a lower polarizing plates 14 and 15 are arranged on the outside of the substrates 11 and 12 as a polarizer and an analyzer, respectively.

The backlight unit 10 comprises: a lamp 1; a light guiding plate 2 arranged on one side of the lamp 1 for uniformity of light; a pair of optical films 3 including an upper, a lower, a right and a left prism sheets, arranged on the light guiding plate 2 for changing a light path and increasing the brightness; and a diffusion film 4 arranged on the optical film 3 for increasing uniformity of light entered into the liquid crystal panel 20.

Additionally, the light guiding plate 2 scatters light emitted from the lamp 1 to transmit the light on the whole surface of panel with the same brightness. The optical film 3 increases the straightness of light emitted from the light guiding plate 2 and concentrates light of all directions on a viewing area of a user. The number of the optical films 3 depends on the use and the characteristics and it can further comprise a film for brightness improvement and a film for polarization selection. The diffusion film 4 disperses and scatters light.

According to the present LCD, the light emitted from the backlight unit 10 is entered into the liquid crystal panel 20 after selecting a polarizing component of a predetermined direction from natural light including all polarizing components by the lower polarizing plate 14 which is a polarizer, and then, the polarizing light entered into the liquid crystal panel 20 is refracted to a predetermined level according to an applied voltage. The refracted polarizing light is partially blocked by the upper polarizing plate 15 as an analyzer and the other polarizing light is emitted to the surface of the liquid crystal panel 20, thereby the liquid crystal panel 10 realizes a desirable gradation.

However, the conventional LCD has several problems.

First, the polarizing plate on the liquid crystal panel can control only horizontally-vibrating light and therefore, complete polarized light can be obtained from the perpendicularly-entered light. However, it is difficult to obtain complete polarized light from the diagonally-entered light. Therefore, if incomplete polarized light is entered into the liquid crystal panel, the emitted light decreases blocking properties of analyzer, thereby generating light leakage in dark. As a result, when a user views the liquid crystal panel diagonally from the region except for a polarizing axis of polarizing plate, the contrast ratio is remarkably lowered.

FIG. 4 is a drawing showing the generation of light leakage due to light dispersion in the conventional LCD. As shown in the drawing, a backlight unit 10 has a dispersion film 4, thereby generating light dispersion and decreasing straightness. As a result, light leakage occurs by incomplete polarized light.

In order to overcome the above problems, a method has been proposed that a light compensation film is added to stably maintain a dark state. However, it still has a problem that the light compensation film is very expensive and additional process is required to add the light compensation film.

### SUMMARY OF THE INVENTION

Accordingly, the present invention has been made in an effort to solve the problems occurring in the related art, and an object of the present invention is to provide a LCD preventing decrease of contrast ratio.

In order to achieve the object, the present invention comprises: an upper and a lower glass substrates as a display, combined with a liquid crystal layer interposed therebetween; a liquid crystal panel comprising an upper and a lower polarizing plates arranged on the outside of the upper and the lower glass substrates; a lamp arranged on the lower part of the liquid crystal panel as a light source; a light guiding plate arranged on one side of the lamp; and a backlight unit comprising an optical film arranged on the upper part of the light guiding plate, wherein the upper polarizing plate has an Anti-Glare layer comprising dispersing particles.

The Anti-Glare layer is arranged on the inner or outer surface of the upper polarizing plate.

The Anti-Glare layer comprises dispersing particles having a Haze over 11 and an average roughness over 0.2 μm.

### BRIEF DESCRIPTION OF THE DRAWINGS

The above objects, and other features and advantages of the present invention will become more apparent after a reading of the following detailed description when taken in conjunction with the drawings, in which:

FIG. 1 is a drawing showing an optical structure of a conventional LCD;

FIGS. 2 and 3 are drawings enlarging a liquid crystal panel and a backlight unit in FIG. 1;

FIG. 4 is a drawing showing the generation of light leakage due to light dispersion in a conventional LCD;

FIG. 5 is a drawing showing an optical structure of LCD according to the present invention; and

FIGS. 6A to 6C are drawings showing an Anti-Glare layer of the present invention.

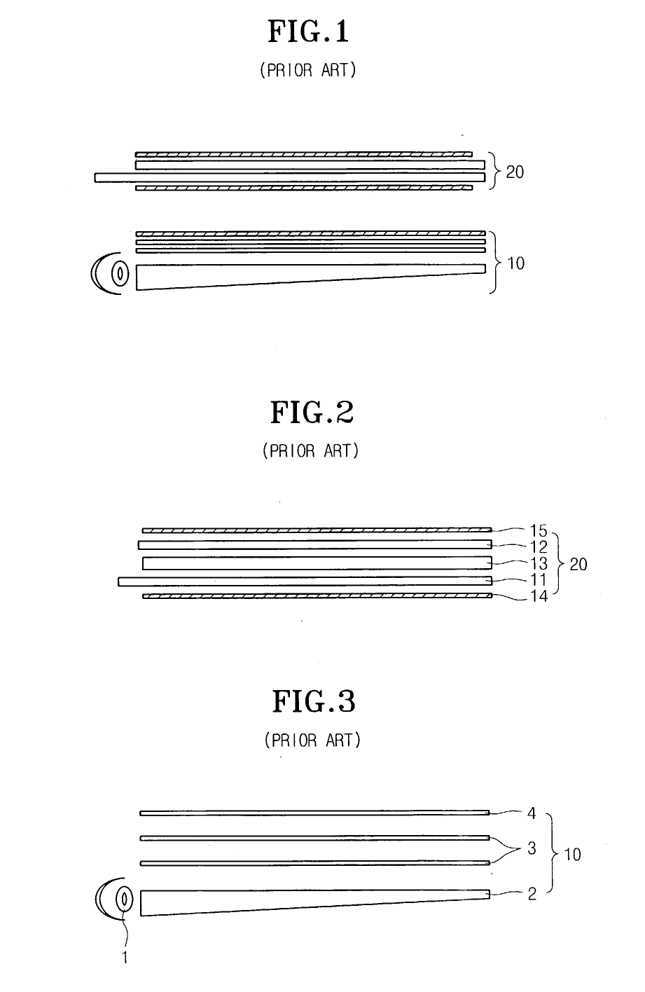

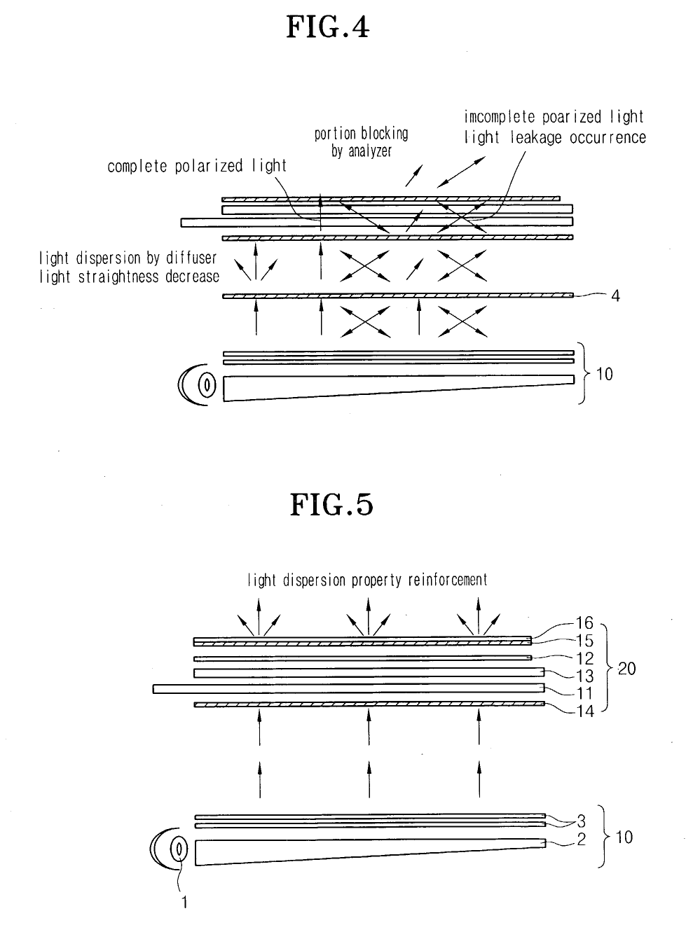

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

FIG. 5 is a drawing showing an optical structure of LCD according to the present invention.

The present LCD comprises a liquid crystal panel 20a as a substantial display device and a backlight unit 10a arranged on the lower part of the liquid crystal panel 20a as a light source.

The backlight unit 10a comprises: a lamp 1, a light guiding plate 2 arranged on one side of the lamp 1 for uniformity of light; and a pair of optical films 3 comprising the upper, the lower, the right and the left prism sheets for changing a light path and increasing the brightness. Compared with the conventional LCD, the backlight unit 10a of the present invention includes no dispersion film for dispersing light.

The liquid crystal panel 20a has a structure that a lower glass substrate 11 and an upper glass substrate 12 are combined with a liquid crystal layer 13 interposed therebetween and a lower and an upper polarizing plates 14 and 15 are arranged on the outside of the substrates 11 and 12 as a polarizer and an analyzer, respectively. The upper polarizing plate 15 includes an Anti-Glare layer comprising dispersing particles, which is a layer for decreasing surface reflection.

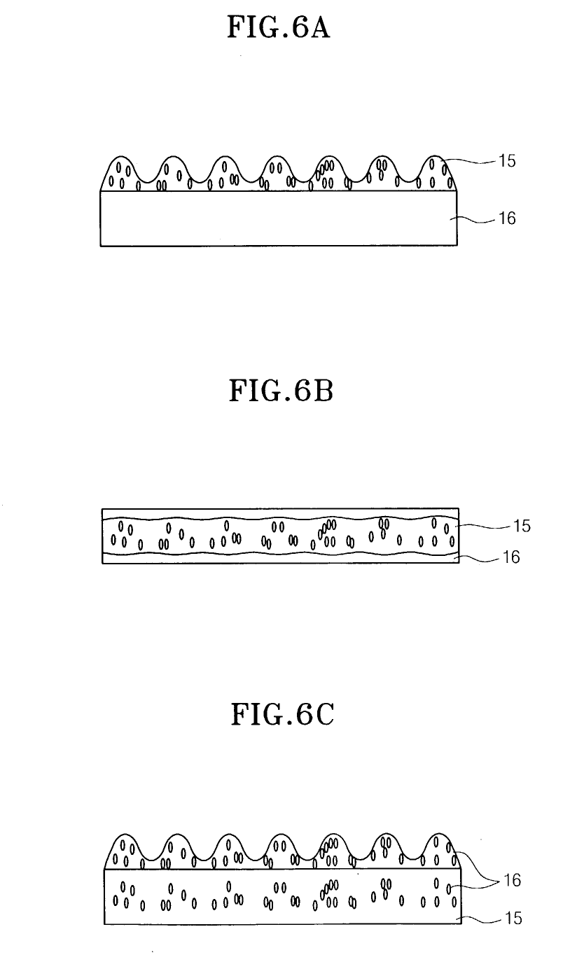

The Anti-Glare layer 16 disperses emitted light, comprising dispersing particles. Referring to FIGS. 6A and 6B, the Anti-Glare layer 16 is formed on the outer or inner surface of the upper polarizing plate 15. And, it is also possible to form the Anti-Glare layer 16 both on the outer and the inner surface of the upper polarizing plate 15, as shown in FIG. 6C.

The Anti-Glare layer 16 comprises dispersing particles having a gloss of 60%, haze over 11 and average roughness over 0.2 μm to disperse light more efficiently.

The LCD of the present invention has several advantages as follows.

First, the diffusion film is arranged on the interface of the backlight unit and the liquid crystal panel to diffuse light, contrary to the prism sheets arranged on the lower part thereof to increase straightness of light and improve light efficiency. In this case, the straightness is decreased for the light diffused by the diffusion film, light efficiency is also lowered and if light is diagonally entered into the liquid crystal panel, light leakage is generated in dark, thereby remarkably lowering a contrast ratio. In the present invention, the diffusion film is arranged on the backlight unit to reduce optical spots generated by prism sheets, such as moare.

The Anti-Glare layer is employed to reduce front reflection to the outside light, not to backlight for convenient use. That is, the Anti-Glare layer is arranged to change surface reflection into anti-reflection. And, the Anti-Glare layer can reduce optical spots generated by prism sheets of backlight unit because it can diffuse the inner light due to backlight.

According to the present invention, the Anti-Glare layer is arranged on the upper polarizing plate of liquid crystal panel instead of removing the diffusion film of the backlight unit, thereby reducing light diffusion due to the diffusion film and preventing decrease of straightness of light. Therefore, it is possible to prevent the generation of light leakage and the reduction of contrast ratio. Moreover, the Anti-Glare layer arranged on the liquid crystal panel reduces optical spots and increases dispersion properties of light, thereby improving the brightness.

As described above, the present invention can improve light efficiency, brightness and contrast ratio by forming the Anti-Glare layer instead of removing the diffusion film from the backlight unit. And, the present invention can improve a viewing angle since a dark state is maintained stably at a tilted angle. Moreover, the present invention has an advantage of reducing the manufacturing cost by removing the diffusion film from the backlight unit.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A liquid crystal display comprising:
an upper and a lower glass substrates as a display, combined with a liquid crystal layer interposed therebetween;
a liquid crystal panel comprising an upper and a lower polarizing plates arranged on the outside of the upper and the lower glass substrates;
a lamp arranged on the lower, part of the liquid crystal panel as a light source;
a light guiding plate arranged on one side of the lamp; and
a backlight unit comprising an optical film arranged on the upper part of the light guiding plate,
wherein the upper polarizing plate has an Anti-Glare layer comprising dispersing particles.

2. The liquid crystal display as set forth in claim 1, wherein the Anti-Glare layer is arranged on the inner of the outer surface of the upper polarizing plate.

3. The liquid crystal display as set forth in claim 1, wherein the Anti-Glare layer has a haze value over 11.

4. The liquid crystal display as set forth in claim 1, wherein the Anti-Glare layer comprises dispersing particles having an average roughness over 0.2 μm.
